(19) United States
(12) Patent Application Publication
(10) Pub. No.: US 2022/0217761 A1
(43) Pub. Date: Jul. 7, 2022

(54) METHOD AND APPARATUS FOR RECONFIGURING CONFIGURED GRANT RESOURCES IN COMMUNICATION SYSTEM

(71) Applicant: ELECTRONICS AND TELECOMMUNICATIONS RESEARCH INSTITUTE, Daejeon (KR)

(72) Inventors: Sung Min OH, Daejeon (KR); Jae Sheung SHIN, Sejong-si (KR); Mi Jeong YANG, Daejeon (KR); Soon Yong LIM, Daejeon (KR); Kwang Ryul JUNG, Daejeon (KR)

(73) Assignee: ELECTRONICS AND TELECOMMUNICATIONS RESEARCH INSTITUTE, Daejeon (KR)

(21) Appl. No.: 17/569,066

(22) Filed: Jan. 5, 2022

(30) Foreign Application Priority Data
Jan. 5, 2021 (KR) 10-2021-0001097

(51) Int. Cl. H04W 72/14; H04L 1/00; H04W 24/08; H04L 1/18; H04W 72/04

(52) U.S. Cl. CPC H04W 72/14; H04L 1/0003; H04W 24/08; H04W 80/02; H04W 72/042; H04W 72/0446; H04L 1/1812

(57) ABSTRACT

An operation method of a terminal in a communication system may comprise: receiving, from a base station, an RRC message including CG configuration information and parameters for a reconfiguration request on a CG resource configured by the CG configuration information; performing a monitoring operation for uplink communication according to the CG configuration information in a period indicated by a first parameter among the parameters; transmitting, to the base station, a MAC CE requesting reconfiguration of the CG resource, when a result of the monitoring operation satisfies a second parameter among the parameters; and receiving, from the base station, configuration information of the CG resource reconfigured according to the MAC CE.

### CROSS-REFERENCE TO RELATED APPLICATIONS

This application claims priority to Korean Patent Application No. 10-2021-0001097, filed on Jan. 5, 2021, with the Korean Intellectual Property Office (KIPO), the entire contents of which are hereby incorporated by reference.

### BACKGROUND

### 1. Technical Field

The present disclosure relates to a technique for configured grant (CG) resource reconfiguration, and more specifically, to a technique for CG resource reconfiguration in consideration of a transmission latency in uplink communication.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

After commercialization of 4G communication system (e.g., communication system supporting long-term evolution (LTE)), a communication system (hereinafter, a communication system supporting new radio (NR)) using a higher frequency band (e.g., a frequency band of 6 GHz or above) than a frequency band (e.g., a frequency band of 6 GHz or below) of the 4G communication is being considered for processing of soaring wireless data. The 5G communication system can support enhanced mobile broadband (eMBB), ultra-reliable low-latency communication (URLLC), massive machine type communication (mMTC), and the like.

Meanwhile, in a communication system (e.g., 5G communication system), uplink communication may be performed using a configured grant (CG) scheme. A CG resource may be preconfigured by a base station, and a terminal may transmit uplink data to the base station using the CG resource. Here, the CG resource may be configured periodically. When the size of the uplink data is larger than the size of the CG resource, the terminal may segment the uplink data in consideration of the size of the CG resource, and may transmit the segmented uplink data using the CG resource. In this case, since a transmission latency of the uplink data occurs, URLLC requirements may not be satisfied.

### SUMMARY

Accordingly, exemplary embodiments of the present disclosure are directed to providing methods and apparatuses for CG resource reconfiguration in consideration of a transmission latency in uplink communication.

According to a first exemplary embodiment of the present disclosure, an operation method of a terminal may comprise: receiving, from a base station, a radio resource control (RRC) message including configured grant (CG) configuration information and parameters for a reconfiguration request on a CG resource configured by the CG configuration information; performing a monitoring operation for uplink communication according to the CG configuration information in a period indicated by a first parameter among the parameters; transmitting, to the base station, a medium access control (MAC) control element (CE) requesting reconfiguration of the CG resource, when a result of the monitoring operation satisfies a second parameter among the parameters; and receiving, from the base station, configuration information of the CG resource reconfigured according to the MAC CE.

The first parameter may be a monitoring timer, and the period may be a period from a start time of the monitoring timer to an end time of the monitoring timer.

In case that a CG type 1 scheme is used, the monitoring timer may start when a CG is activated by the CG configuration information, and in case that a CG type 2 scheme is used, the monitoring timer may start when downlink control information (DCI) requesting activation of a CG is received the base station.

The result of the monitoring operation indicates a number of segmentations of a radio link control (RLC) service data unit (SDU) transmitted in the CG resource, and when the number of segmentations is equal to or greater than a threshold according to the second parameter, the MAC CE may be transmitted to the base station.

The result of the monitoring operation indicates a maximum size of an RLC SDU transmitted in the CG resource, and when the maximum size is equal to or greater than a threshold according to the second parameter, the MAC CE may be transmitted to the base station.

The result of the monitoring operation indicates a number of times of performing a hybrid automatic repeat request (HARQ) retransmission operation for data transmitted in the CG resource, and when the number of times is greater than or equal to a threshold according to the second parameter, the MAC CE may be transmitted to the base station.

The MAC CE may include first information indicating a CG associated with the CG resource for which reconfiguration is requested, second information requesting a change of a modulation and coding scheme (MCS) level for the CG indicated by the first information, and third information requesting a change in a buffer size for the CG indicated by the first information.

The operation method may further comprise, before the receiving of the configuration information of the reconfigured CG resource, receiving, from the base station, DCI requesting deactivation of the CG resource for which the reconfiguration is requested by the MAC CE.

When a CG type 1 scheme is used, the configuration information of the reconfigured CG resource may be included in an RRC configuration message, and when a CG type 2 scheme is used, the configuration information of the reconfigured CG resource may be included in DCI.

According to a second exemplary embodiment of the present disclosure, an operation method of a base station may comprise: transmitting, to a terminal, a radio resource control (RRC) reconfiguration message including configured grant (CG) configuration information and parameters for a reconfiguration request on a CG resource configured by the CG configuration information; receiving, from the terminal, a medium access control (MAC) control element (CE) requesting reconfiguration of the CG resource in the CG resource; reconfiguring the CG resource based on information included in the MAC CE; and transmitting, to the terminal, configuration information of the reconfigured CG resource.

The parameters may include a first parameter indicating a monitoring timer for the reconfiguration request on the CG resource, a second parameter indicating a threshold for a number of segmentations of a radio link control (RLC) service data unit (SDU) transmitted in the CG resource, a third parameter indicating a threshold for a maximum size of the RLC SDU, and a fourth parameter indicating a threshold for a number of times of performing a hybrid automatic repeat request (HARQ) retransmission operation for data transmitted in the CG resource.

The MAC CE may include first information indicating a CG associated with the CG resource for which reconfiguration is requested, second information requesting a change of a modulation and coding scheme (MCS) level for the CG indicated by the first information, and third information requesting a change in a buffer size for the CG indicated by the first information.

The operation method may further comprise, when the MAC CE is received, transmitting, to the terminal, downlink control information (DCI) requesting deactivation of the CG resource.

When a CG type 1 scheme is used, the configuration information of the reconfigured CG resource may be included in an RRC configuration message, and when a CG type 2 scheme is used, the configuration information of the reconfigured CG resources may be included in DCI.

According to a third exemplary embodiment of the present disclosure, a terminal may comprise: a processor; a memory electronically communicating with the processor; and instructions stored in the memory, wherein when executed by the processor, the instructions cause the terminal to: receive, from a base station, a first message including configured grant (CG) configuration information and parameters for a reconfiguration request on a CG resource configured by the CG configuration information; perform a monitoring operation for uplink communication according to the CG configuration information in a period indicated by a first parameter among the parameters; and in response to determining that a transmission latency for the uplink communication occurs by the monitoring operation, transmit, to the base station, a second message requesting reconfiguration of the CG resource.

When a number of segmentations of a radio link control (RLC) service data unit (SDU) transmitted in the CG resource, a maximum size of the RLC SDU, or a number of performing a hybrid automatic repeat request (HARQ) retransmission operation for data transmitted in the CG resource is equal to or greater than a second parameter among the parameters, it may be determined that the transmission latency occurs.

The second message may include first information indicating a CG associated with the CG resource for which reconfiguration is requested, second information requesting a change of a modulation and coding scheme (MCS) level for the CG indicated by the first information, and third information requesting a change in a buffer size for the CG indicated by the first information.

The instructions may cause the terminal to receive, from the base station, downlink control information (DCI) requesting deactivation of the CG resource for which reconfiguration is requested by the second message.

The instructions may cause the terminal to receive, from the base station, a third message including configuration information of the CG resource reconfigured according to the second message.

When a CG type 1 scheme is used, the third message may be a radio resource control (RRC) reconfiguration message, and when a CG type 2 scheme is used, the third message may be DCI.

According to the present disclosure, a terminal may determine whether to reconfigure a CG resource based on the number of segments of a data unit, the maximum size of the data unit, and/or the number of times of performing a HARQ retransmission operation. When reconfiguration of the CG resource is required, the terminal may transmit a message requesting reconfiguration of the CG resource to the base station. The base station may reconfigure the CG resource according to the request of the terminal, and may inform the terminal of information on the reconfigured CG resource. The terminal may transmit uplink data by using the CG resource reconfigured by the base station. Accordingly, degradation of service quality in uplink communication using the CG resource can be prevented, and performance of the communication system can be improved.

### BRIEF DESCRIPTION OF DRAWINGS

FIG. 1 is a conceptual diagram illustrating a first exemplary embodiment of a communication system;

FIG. 2 is a block diagram illustrating a first exemplary embodiment of a communication node constituting a communication system;

FIG. 3 is a sequence chart illustrating a first exemplary embodiment of an uplink communication method according to the CG type 1 scheme in a communication system.

FIG. 4 is a sequence chart illustrating a first exemplary embodiment of an uplink communication method according to the CG type 2 scheme in a communication system.

FIG. 5 is a conceptual diagram illustrating a first exemplary embodiment of an uplink communication method according to a CG scheme in a communication system.

FIG. 6 is a sequence chart illustrating a first exemplary embodiment of a CG resource reconfiguration method when the CG type 1 scheme is used in a communication system.

FIG. 7 is a sequence chart illustrating a first exemplary embodiment of a CG resource reconfiguration method when the CG type 2 scheme is used in a communication system.

FIG. 8 is a conceptual diagram illustrating a first exemplary embodiment of a CGRR-MAC CE in a communication system.

### DETAILED DESCRIPTION OF THE EMBODIMENTS

Embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication networks. Here, the communication system may be used in the same sense as a communication network.

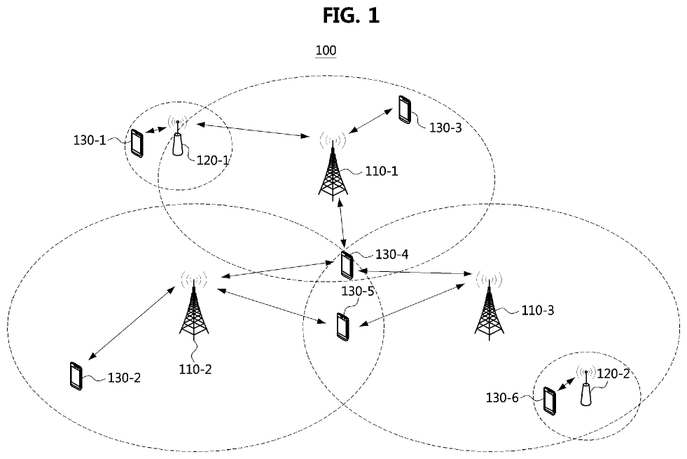

FIG. 1 is a conceptual diagram illustrating a first exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4th generation (4G) communication (e.g., long term evolution (LTE), LTE-advanced (LTE-A)), 5th generation (5G) communication (e.g., new radio (NR)), or the like. The 4G communication may be performed in a frequency band of 6 gigahertz (GHz) or below, and the 5G communication may be performed in a frequency band of 6 GHz or above as well as the frequency band of 6 GHz or below.

For example, for the 4G and 5G communications, the plurality of communication nodes may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, a filtered OFDM based communication protocol, a cyclic prefix OFDM (CP-OFDM) based communication protocol, a discrete Fourier transform spread OFDM (DFT-s-OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a generalized frequency division multiplexing (GFDM) based communication protocol, a filter bank multi-carrier (FBMC) based communication protocol, a universal filtered multi-carrier (UFMC) based communication protocol, a space division multiple access (SDMA) based communication protocol, or the like.

Also, the communication system 100 may further include a core network. When the communication system 100 supports the 4G communication, the core network may comprise a serving gateway (S-GW), a packet data network (PDN) gateway (P-GW), a mobility management entity (MME), and the like. When the communication system 100 supports the 5G communication, the core network may comprise a user plane function (UPF), a session management function (SMF), an access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

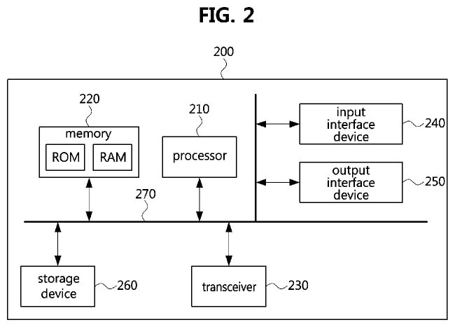

FIG. 2 is a block diagram illustrating a first exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may be connected to the processor 210 via an individual interface or a separate bus, rather than the common bus 270. For example, the processor 210 may be connected to at least one of the memory 220, the transceiver 230, the input interface device 240, the output interface device 250, and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. The communication system 100 including the base stations 110-1, 110-2, 110-3, 120-1, and 120-2 and the terminals 130-1, 130-2, 130-3, 130-4, 130-5, and 130-6 may be referred to as an ‘access network’. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, a evolved Node-B (eNB), a base transceiver station (BTS), a radio base station, a radio transceiver, an access point, an access node, a road side unit (RSU), a radio remote head (RRH), a transmission point (TP), a transmission and reception point (TRP), an eNB, a gNB, or the like.

Here, each of the plurality of terminals 130-1, 130-2, 130-3, 130-4, 130-5, and 130-6 may refer to a user equipment (UE), a terminal, an access terminal, a mobile terminal, a station, a subscriber station, a mobile station, a portable subscriber station, a node, a device, an Internet of things (IoT) device, a mounted apparatus (e.g., a mounted module/device/terminal or an on-board device/terminal, etc.), or the like.

Hereinafter, uplink communication methods according to the CG scheme will be described. Even when a method (e.g., transmission or reception of a data packet) performed at a first communication node among communication nodes is described, the corresponding second communication node may perform a method (e.g., reception or transmission of the data packet) corresponding to the method performed at the first communication node. That is, when an operation of a terminal is described, the corresponding base station may perform an operation corresponding to the operation of the terminal. Conversely, when an operation of the base station is described, the corresponding terminal may perform an operation corresponding to the operation of the base station.

Meanwhile, in a communication system, uplink communication may be performed based on a CG scheme. When the CG scheme is used, a terminal may transmit uplink data by using a preconfigured uplink resource (e.g., CG resource) without a resource allocation procedure by a base station.

The CG scheme may be classified into a CG type 1 scheme and a CG type 2 scheme. When the CG type 1 scheme is used, a CG resource may be configured and activated by a radio resource control (RRC) signaling procedure. When the CG type 2 scheme is used, a CG resource may be configured by an RRC signaling procedure, and may be activated by a physical (PHY) signaling procedure (e.g., downlink control information (DCI)).

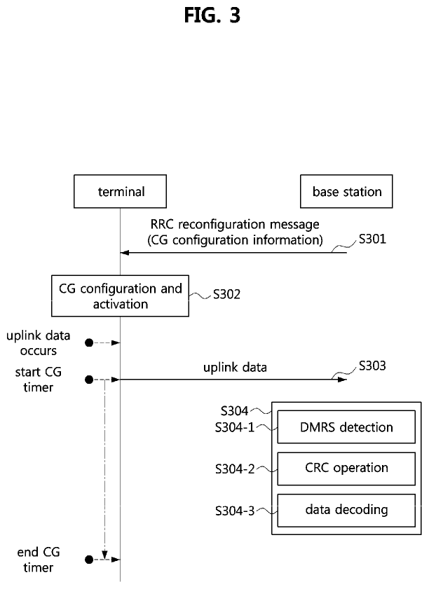

FIG. 3 is a sequence chart illustrating a first exemplary embodiment of an uplink communication method according to the CG type 1 scheme in a communication system.

Referring to FIG. 3, a communication system may include a base station and a terminal. The base station may be the base station 110-1, 110-2, 110-3, 120-1, or 120-2 shown in FIG. 1, and the terminal may be the terminal 130-1, 130-2, 130-3, 130-4, 130-5, or 130-6 shown in FIG. 1. Each of the base station and the terminal may be configured identically or similarly to the communication node 200 shown in FIG. 2.

The base station may transmit an RRC reconfiguration message including CG configuration information to the terminal (S301). The terminal may receive the RRC reconfiguration message from the base station, and may identify the CG configuration information included in the RRC reconfiguration message. The CG configuration information may mean ‘CG information elements (IEs)’, ‘CG configuration parameters’, or ‘CG parameters’. In a step S302, the terminal may configure a CG based on the CG configuration information, and may activate the configured CG. In exemplary embodiments, the CG may mean a CG resource, parameters for the CG, and/or operations for the CG. The CG resource may be configured periodically.

When uplink data to be transmitted through the CG resource occurs, the terminal may transmit the uplink data to the base station using the CG resource configured by the base station (S303). In addition, the terminal may start a CG timer at the time of transmission of the uplink data. From a start time of the CG timer until an end time of the CG timer, the terminal may perform a PDCCH monitoring operation on a UE-specific search space by using a configured scheduling-radio network temporary identifier (CS-RNTI).

If DCI requesting retransmission of the uplink data (e.g., DCI including a new data indicator (NDI) set to 1) is received from the base station before expiration of the CG timer, the terminal may perform a retransmission procedure of the uplink data. That is, when the NDI included in the DCI is set to 1, the terminal may determine that a resource allocated by the DCI is a retransmission resource. The retransmission procedure of the uplink data may be performed using the resource indicated by the DCI. If the DCI requesting retransmission of the uplink data is not received from the base station before expiration of the CG timer, the terminal may determine that the uplink data has been successfully received at the base station.

The base station may perform an operation of receiving uplink data by performing a monitoring operation on the CG resource (S304). The monitoring operation may be performed periodically. For example, the base station may perform an operation of detecting a demodulation reference signal (DMRS) in the CG resource (S304-1). The DMRS detection operation may be an autocorrelation operation for a DMRS sequence configured between the base station and the terminal. When an energy level resulting from the DMRS detection operation is equal to or greater than a threshold, the base station may determine that uplink data is transmitted in the CG resource. When the energy level resulting from the DMRS detection operation is less than the threshold, the base station may determine that uplink data is not transmitted in the CG resource.

When it is determined that uplink data is transmitted in the CG resource, the base station may perform a cyclic redundancy check (CRC) operation on the uplink data obtained from the CG resource (S304-2). If a result of the CRC operation is successful, the base station may perform a decoding operation of the uplink data (S304-3). If the result of the CRC operation is failure, the base station may perform a resource allocation procedure for retransmission of the uplink data.

In the above-described step S301, the RRC reconfiguration message may be transmitted to configure a data radio bearer (DRB) of the terminal. The RRC reconfiguration message may include an index of the DRB, a logical channel identifier (LCID) mapped to the DRB, and the like. For example, the RRC reconfiguration message may include a LogicalChannelConfig IE, and the LogicalChannelConfig IE may include parameters defined in Table 1 below (e.g., parameters related to a logical channel). The parameters defined in Table 1 may be used for a logical channel prioritization (LCP) operation and a buffer status report (BSR) operation in a medium access control (MAC) layer of the terminal. In exemplary embodiments, a radio link control (RLC) layer may be an entity performing functions of the RLC layer, a MAC layer may be an entity performing functions of the MAC layer, and a PHY layer may be an entity performing functions of the PHY layer.

TABLE 1

| | IE |
|---|---|
| LCP-related parameters | Priority |
| | prioritizedBitRate |
| | bucketSizeDuration |
| | allowedServingCells |
| | allowedSCS-List |
| | maxPUSCH-Duration |
| | configuredGrantType1Allowed, |
| | allowedCG-List |
| | allowedPHY-PriorityIndex |
| BSR-related parameters | logicalChannelGroup |
| | schedulingRequestID |
| | logicalChannelSR-Mask |
| | logicalChannelSR-DelayTimerApplied |

The terminal may identify the parameters defined in Table 1 by receiving the RRC reconfiguration message in the step S301. configuredGrantType1Allowed set to true may indicate that the CG type 1 scheme is used for the logical channel mapped with the DRB. In order to apply multiple CGs, allowedCG-List may include indexes of CG parameters applied to the logical channel. The index of the CG parameter may be set by configuredGrantConfigIndexMAC included in a ConfiguredGrantConfig IE.

A higher layer (e.g., RLC layer) of the terminal may transmit, to the MAC layer of the terminal, information (e.g., buffer information) indicating that data to be transmitted according to the CG type 1 scheme exists. The MAC layer of the terminal may receive the buffer information from the higher layer, and may update buffer information for the logical channel based on the received buffer information. The MAC layer of the terminal may generate a MAC protocol data unit (PDU) using data existing in an RLC buffer when there is a CG resource according to the CG type 1 scheme, and may deliver the MAC PDU to a lower layer (e.g., PHY layer) of the terminal.

In addition, the RRC reconfiguration message transmitted in the step S301 may further include the ConfiguredGrantConfig IE, and the ConfiguredGrantConfig IE may include parameters defined in Table 2 below. The ConfiguredGrantConfig IE may include transmission periodicity information, frequency resource information, time resource information, and transport block size (TBS) information for the CG type 1 scheme.

TABLE 2

| | IE |
|---|---|
| Common parameters for | frequencyHopping |
| the CG type 1 scheme and | cg-DMRS-Configuration |
| the CG type 2 scheme | mcs-Table |
| | mcs-TableTransformPrecoder |
| | uci-OnPUsch |
| | resourceAllocation |
| | rbg-Size |
| | powerControlLoopToUse |
| | p0-PUSCH-Alpha |
| | transformPrecoder |
| | nrofHARQ-Processes |
| | repK |
| | repK-RV |
| | periodicity |
| | configuredGrantTimer |
| | harq-ProcID-Offset |
| | configuredGrantConfigIndexMAC |
| | phy-PriorityIndex |
| Parameters for the CG | timeDomainOffset |
| type 1 scheme | timeDomainAllocation |
| (rrc- | frequencyDomainAllocation |
| ConfiguredUplinkGrant) | antennaPort |
| | dmrs-SeqInitialization |
| | precodingAndNumberofLayers |
| | srs-ResourceIndicator |
| | mcsAndTBS |
| | frequencyHoppingOffset |
| | pathlosRefereceIndex |
| | pusch-RepTypeIndicator |
| | frequencyHoppingPUSCH-RepTypeB |
| | timeReferenceSFN |

The terminal may identify the parameters defined in Table 2 by receiving the RRC reconfiguration message in the step S301. When the CG type 1 scheme is used, the parameters may be transmitted by the RRC reconfiguration message (e.g., rrc-ConfiguredUplinkGrant) instead of DCI.

[Periodic Configuration of CG Resource]

A periodicity (e.g., transmission periodicity) of a CG resource according to the CG type 1 scheme may be determined based on Equation 1 below.

$$SFN \times Ns , f \times Nsy , s + slot \times Nsy , s + symbol = ( timeReferenceSFN \times Ns , f \times Nsy , s + timeDomainOffset \times Nsy , s + S + n \times periodicity ) modulo ( 1024 \times Ns , f \times Nsy , s ) \qquad [ Equation 1 ]$$

Ns, f may be the number of slots per radio frame, and Nsy, s may be the number of symbols per slot. timeReferenceSFN, timeDomainOffset, and periodicity may be parameters included in the rrc-ConfiguredUplinkGrant IE. S may be a start symbol within a slot. S may be set by an RRC parameter timeDomainAllocation. A value m of timeDomainAllocation may indicate an index m+1 of a PUSCH-TimeDomainAllocation List each element of which is composed of K₂, a physical uplink shared channel (PUSCH) mapping type, and a start and length indicator (SLIV). K₂ may mean an interval between DCI and a PUSCH in the time domain. The SLIV may indicate a combination of an index of a first symbol of a PUSCH resource and a length of the PUSCH resource. The index of the first symbol of the PUSCH resource and the length of the PUSCH resource may be determined based on Equation 2 below.

If (SLIV/14)+(SLIV mod 14)>=14 then

L=15−SLIV/14 and S=13−SLIV mod 14

Else

L=SLIV/14+1 and S=SLIV mod 14

End [Equation 2]

Based on Equation 1, n having a value closest to the current system frame number (SFN), slot, and symbol may be determined, and the CG resource may be configured according to a periodicity of (determined n×periodicity). Here, the determined n may increase by one.

[Configuration of Frequency and Time Resource]

A frequency and time resource for the CG type 1 scheme may be configured by RRC parameters. The time resource for the CG type 1 scheme (e.g., the length L of the time resource) may be configured by the RRC parameter timeDomainAllocation. The frequency resource for the CG type 1 scheme may be configured by the parameter resourceAllocation configuring a frequency resource allocation scheme (e.g., bitmap or resource indication value (RIV)) and the parameter frequencyDomainAllocation configuring a resource allocation region (e.g., start physical resource block (PRB) and the number of PRBs) according to the frequency resource allocation scheme.

When resourceAllocation is set to resourceAllocationType0, the frequency resources for the CGtype 1 scheme may be indicated by a bitmap. The entire bandwidth may be divided into resource block group (RBG) units, and each bit included in the bitmap (e.g., frequencyDomainAllocation) may indicate whether one RBG is configured for the CG type 1 scheme. That is, one bit included in the bitmap may be mapped one-to-one with one RBG.

The size of the RBG may be determined based on the RRC parameter rbg-Size and a bandwidth size. Since the field rbg-Size in the CG parameters is set to config2, the size of the RBG may be determined based on Table 3 according to a bandwidth of the communication system (e.g., a size of a bandwidth part (BWP)).

TABLE 3

| BWP size | Configuration 1 | Configuration 2 |
|---|---|---|
| 1~36 | 2 | 4 |
| 37~72 | 4 | 8 |
| 73~144 | 8 | 16 |
| 145~275 | 16 | 16 |

When resourceAllocation is set to resourceAllocationType1, the frequency resources for the CG type 1 scheme may be indicated by an RIV (e.g., frequencyDomainAllocation). As shown in Equation 3 below, the RIV may indicate a combination of a start RB (e.g., RBₛₜₐᵣₜ) and the number of RBs (e.g., L_{RBs}). N_{BWP} may indicate the bandwidth size (e.g., the number of BWPs).

If (L_{RBs}−1)<=floor(N_{BWP}/2) then

RIV=N_{BWP}×(L_{RBs}−1)+RBₛₜₐᵣₜ

Else

RIV=N_{BWP}×(N_{BWP}−L_{RBs}+1)+(N_{BWP}−1−RBₛₜₐᵣₜ)

Where L_{RBs}>=1 and shall not exceed N_{BWP}−RBₛₜₐᵣₜ [Equation 3]

[TBS Configuration]

When the CG type 1 scheme is used, PHY parameters for PUSCH transmission may be transmitted through the RRC message (e.g., RRC reconfiguration message). Therefore, main parameters for calculating a TBS may be included in rrc-ConfiguredUplinkGrant. The TBS may be determined based on Equation 4 below.

TBS=Quantization(N_{RE}×R×Qₘ×v) [Equation 4]

‘N_{RE}=N_{RE′}×N_{RB}’ may be defined. N_{RB} may be the number of allocated RBs. R may be a code rate. Qₘ may be a modulation order. v may be the number of layers. The main parameters for determining the TBS may be N_{RB}, a modulation and coding scheme (MCS) level, and the number of layers. N_{RB} may be set in the above-described resource configuration procedure. The MCS level may be set by mcs-Table and mcsAndTBS included in rrc-ConfiguredUplinkGrant. The mcs-Table may indicate an MCS table composed of a list of modulation orders and code rates. mcsAndTBS may mean an index in the MCS table. The number of layers may be set by precodingAndNumberofLayers included in rrc-ConfiguredUplinkGrant.

When the CG type 1 scheme is used, parameters required for uplink communication (e.g., a periodicity of the CG resource, frequency resource, time resource, TBS, etc.) may be configured by the RRC reconfiguration message. When the configuration operation according to the RRC reconfiguration message is completed, the terminal may activate a CG (e.g., CG resource). When data to be transmitted according to the CG type 1 scheme occurs and a CG resource exists, the terminal may determine a HARQ process ID for transmission of the data based on Equation 5 below. periodicity and nrofHARQ-Processes may be included in ConfiguredGrantConfig.

HARQ Process ID=[floor(CURRENT_{symbol}/periodicity)]modulo nrofHARQ−Processes [Equation 5]

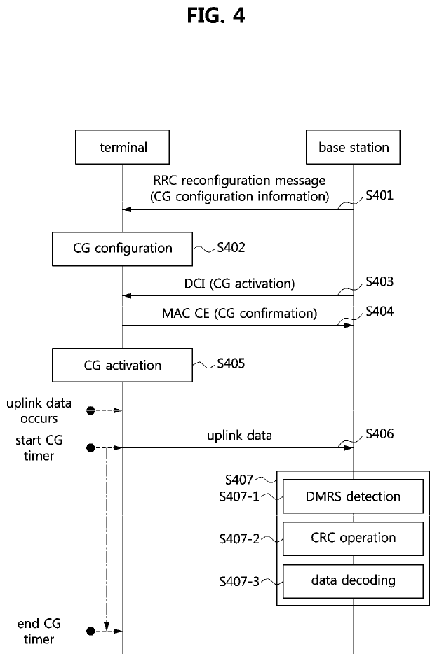

FIG. 4 is a sequence chart illustrating a first exemplary embodiment of an uplink communication method according to the CG type 2 scheme in a communication system.

Referring to FIG. 4, a communication system may include a base station and a terminal. The base station may be the base station 110-1, 110-2, 110-3, 120-1, or 120-2 shown in FIG. 1, and the terminal may be the terminal 130-1, 130-2, 130-3, 130-4, 130-5, or 130-6 shown in FIG. 1. Each of the base station and the terminal may be configured identically or similarly to the communication node 200 shown in FIG. 2.

The base station may transmit an RRC reconfiguration message including CG configuration information (e.g., basic parameters for a CG) to the terminal (S401). The terminal may receive the RRC reconfiguration message from the base station, and may identify the CG configuration information included in the RRC reconfiguration message. The terminal may configure parameters, resources, and/or operations for uplink communication based on the CG configuration information (S402). That is, the CG may be configured in the step S402.

The base station may transmit DCI for activating the CG (hereinafter, referred to as ‘activation DCI’) to the terminal (S403). The activation DCI may include periodicity information of a CG resource, frequency resource information, time resource information, TBS information, and the like. The terminal may receive the activation DCI from the base station, and may identify the information included in the activation DCI. When the information included in the activation DCI is identified, the terminal may transmit a MAC control element (CG) for CG confirmation to the base station (S404). When the MAC CE for CG confirmation is received from the terminal, the base station may determine that the activation DCI has been successfully received at the terminal. The step S404 may be an optional operation.

When the activation DCI is received, the terminal may activate the CG (e.g., CG resource) (S405). The CG resource may be configured periodically. When uplink data to be transmitted through the CG resource occurs, the terminal may transmit the uplink data to the base station using the CG resource configured by the base station (S406). In addition, the terminal may start a CG timer at the time of transmission of the uplink data. From a start time of the CG timer until an end of the CG timer, the terminal may perform a PDCCH monitoring operation on a UE-specific search space by using a CS-RNTI.

When DCI requesting retransmission of the uplink data (e.g., DCI including an NDI set to 1) is received from the base station before expiration of the CG timer, the terminal may perform a retransmission procedure of the uplink data. That is, when the NDI included in the DCI is set to 1, the terminal may determine that a resource allocated by the DCI is a retransmission resource. The uplink data retransmission procedure may be performed using the resource indicated by the DCI. If the DCI requesting retransmission of the uplink data is not received from the base station before expiration of the CG timer, the terminal may determine that the uplink data has been successfully received at the base station.

The base station may perform an operation of receiving the uplink data by performing a monitoring operation on the CG resource (S407). The monitoring operation may be performed periodically. For example, the base station may perform an operation of detecting a DMRS in the CG resource (S407-1). The DMRS detection operation may be an autocorrelation operation for a DMRS sequence configured between the base station and the terminal.

When an energy level resulting from the DMRS detection operation is equal to or greater than a threshold, the base station may determine that uplink data is transmitted in the CG resource. When the energy level resulting from the DMRS detection operation is less than the threshold, the base station may determine that uplink data is not transmitted in the CG resource. When it is determined that uplink data is transmitted in the CG resource, the base station may perform a CRC operation on the uplink data obtained from the CG resource (S407-2). If a result of the CRC operation is successful, the base station may perform a decoding operation of the uplink data (S407-3). If the result of the CRC operation is failure, the base station may perform a resource allocation procedure for retransmission of the uplink data.

On the other hand, when the CG type 2 scheme is used, basic parameters for a CG may be configured by the RRC reconfiguration message, and a periodicity of a CG resource, frequency resource, time resource, and TBS may be configured by DCI for activating the CG (i.e., activation DCI). The RRC reconfiguration message transmitted in the step S401 may be used to configure a DRB and a logical channel of the terminal. The RRC reconfiguration message may include an index of the DRB, an LCID mapped to the DRB, and the like. In addition, the RRC reconfiguration message may include logical channel-related parameters (e.g., parameters defined in Table 1) for performing an LCP operation and a BSR operation in the MAC layer of the terminal.

In order to inform that the CG type 2 scheme is applied in the logical channel mapped to the DRB, configuredGrantType1Allowed may not be configured, and indexes of parameters for the CG type 2 scheme applied to the logical channel may be included in allowedCG-List. In this case, the higher layer (e.g., RLC layer) of the terminal may transmit, to the MAC layer of the terminal, information (e.g., buffer information) indicating that data to be transmitted according to the CG type 2 scheme exists, and the MAC layer of the terminal may update buffer information for the logical channel based on the received buffer information. When an uplink resource according to the CG type 2 scheme occurs, the MAC layer of the terminal may generate a MAC PDU by using data stored in an RLC buffer, and deliver the MAC PDU to the lower layer (e.g., PHY layer) of the terminal.

The RRC reconfiguration message may include a ConfiguredGrantConfig IE defined in Table 4 below, and the ConfiguredGrantConfig IE may include basic parameters for the CG type 2 scheme.

TABLE 4

| | IE |
|---|---|
| Common parameters for | frequencyHopping |
| the CG type 1 scheme and | cg-DMRS-Configuration |
| the CG type 2 scheme | mcs-Table |
| | mcs-TableTransformPrecoder |
| | uci-OnPUsch |
| | resourceAllocation |
| | rbg-Size |
| | powerControlLoopToUse |
| | p0-PUSCPI-Alpha |
| | transformPrecoder |
| | nrofHARQ-Processes |
| | repK |
| | repK-RV |
| | periodicity |
| | configuredGrantTimer |
| | harq-ProcID-Offset |
| | configuredGrantConfigIndexMAC |
| | phy-PriorityIndex |

[Periodic Configuration of CG Resource]

A periodicity (e.g., transmission periodicity) of a CG resource according to the CG type 2 scheme may be determined based on Equation 6 below. In Equation 6, parameters may be configured by the RRC message (e.g., RRC reconfiguration message) and DCI (e.g., activation DCI).

$$SFN \times Ns , f \times Nsy , s + slot \times Nsy , s + symbol = ( {SFN}_{start \_ time} \times Ns , f \times Nsy , s + {slot}_{start \_ time} \times Nsy , s + {symbol}_{start \_ time} + n \times periodicity ) modulo ( 1024 \times Ns , f \times Nsy , s ) \qquad [ Equation 6 ]$$

Ns,f may be the number of slots per radio frame, and Nsy,s may be the number of symbols per slot. SFNstart_time, slotstart_time, and symbolstart_time may indicate a time resource of a PUSCH allocated by the activation DCI. periodicity may be a parameter included in the above-described rrc-ConfiguredUplinkGrant IE. The CG resource may be configured according to a periodicity of (n×periodicity) based on an initial PUSCH time indicated by the activation DCI.

[Configuration of Frequency and Time Resource]

A frequency and time resource for the CG type 2 scheme may be configured by parameters included in the activation DCI. The time resource for the CG type 2 scheme may be configured by Time Domain Resource Assignment included in the activation DCI. A value m of Time Domain Resource Assignment may indicate an index m+1 of a PUSCH-TimeDomainAllocation List each element of which is composed of K₂, a PUSCH mapping type, and an SLIV. K₂ may mean an interval between the activation DCI and a PUSCH in the time domain. The SLIV may indicate a combination of an index of a first symbol of a PUSCH resource and a length of the PUSCH resource.

The frequency resource for the CG type 2 scheme may be configured by a parameter resourceAllocation configuring a frequency resource allocation scheme (e.g., bitmap or RIV) and a parameter frequencyDomainAllocation configuring a resource allocation region (e.g., start PRB and the number of PRBs) according to the frequency resource allocation scheme. resourceAllocation may be included in the RRC message (e.g., RRC reconfiguration message), and frequencyDomainAllocation may be included in the DCI.

When resourceAllocation is set to resourceAllocationType0, the frequency resource for the CG type 2 scheme may be indicated by a bitmap. The entire bandwidth may be divided in RBG units, and each bit included in the bitmap (e.g., frequencyDomainAllocation) may indicate whether one RBG is configured for the CG type 2 scheme. That is, one bit included in the bitmap may be mapped one-to-one with one RBG. The size of the RBG may be determined based on Table 3 described above.

When resourceAllocation is set to resourceAllocationType1, the frequency resource for the CG type 2 scheme may be indicated by an RIV (e.g., frequencyDomainAllocation). The terminal may derive a start RB and the number of RBs by using the value (i.e., RIV) of frequencyDomainAllocation included in the activation DCI.

[TBS Configuration]

When the CG type 2 scheme is used, PHY parameters for PUSCH transmission may be transmitted through the activation DCI. A TBS may be determined based on Equation 4 above. The main parameters for determining the TBS may be N_{RB} (i.e., the number of allocate RBs), an MCS level, and the number of layers. N_{RB} may be set in the above-described resource configuration procedure. The MCS level may be set by mcs-Table included in the RRC message and a modulation and coding scheme included in the activation DCI. The number of layers may be set by precoding information and number of layers included in the activation DCI.

Meanwhile, the RRC message and the DCI may be used together to configure the CG type 2 scheme. A data transmission procedure according to the CG type 2 scheme may be the same as the data transmission procedure according to the CG type 1 scheme. When the CG type 1 scheme or the CG type 2 scheme is used, it may be difficult to change the configured resource. In this case, the URLLC requirements may not be satisfied.

In the CG resource configuration procedure, characteristics of an application service such as 5G Quality of Service Identifier (i.e., 5QI) may be considered. The 5QI may define a packet delay budget, a packet error rate, a default maximum data burst volume, and the like for of an application service. However, since actual application services are more diverse than services defined by the 5QI, the configured CG resource may not match the actual traffic characteristics. In this case, the following situation may occur.

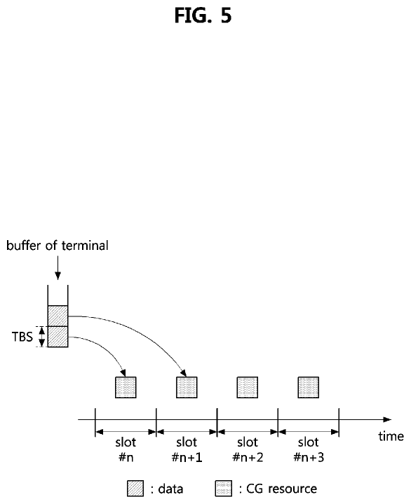

FIG. 5 is a conceptual diagram illustrating a first exemplary embodiment of an uplink communication method according to a CG scheme in a communication system.

Referring to FIG. 5, the size of data existing in a buffer (e.g., CG buffer) of the terminal may be larger than a TBS configured by CG configuration information. In this case, the RLC layer of the terminal may segment a data unit (e.g., RLC SDU), and the segmented data units may be transmitted in CG resources. For example, a segmented data unit #1 may be transmitted in a CG resource of a slot #n, and a segmented data unit #2 may be transmitted in a CG resource of a slot #n+1. In this case, a data transmission latency may increase.

When the periodicity of the CG resource is set to be short, a UL grant may occur every short period. In this case, the terminal may not be able to perform a BSR operation for requesting an additional resource, and the data unit may be continuously segmented in the RLC layer of the terminal. Accordingly, the data transmission latency may increase. In order to solve the above-described problem, a reconfiguration operation for increasing the CG resource (e.g., the number of RBs) and/or a reconfiguration operation for lowering an MCS level may be required. In addition, since a channel state varies according to movement of the terminal, a semi-persistent link adaptation technique is needed to ensure resource efficiency and service quality.

Hereinafter, CG resource reconfiguration procedures will be described. The CG resource reconfiguration procedure may include a procedure of configuring parameters for CG resource reconfiguration, a procedure of monitoring for CG resource reconfiguration, and a procedure of requesting CG resource reconfiguration.

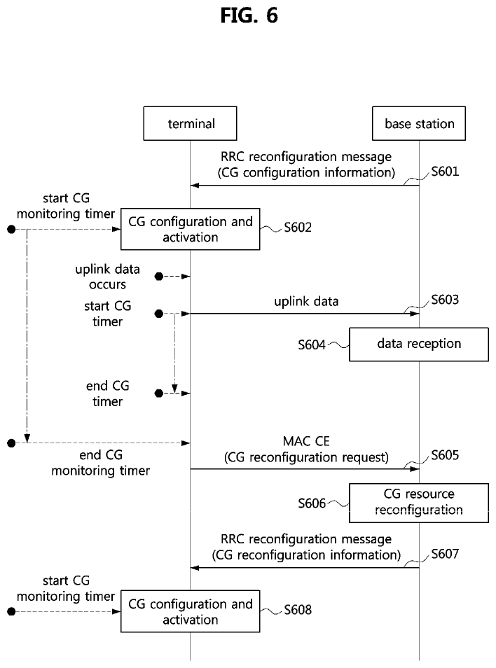

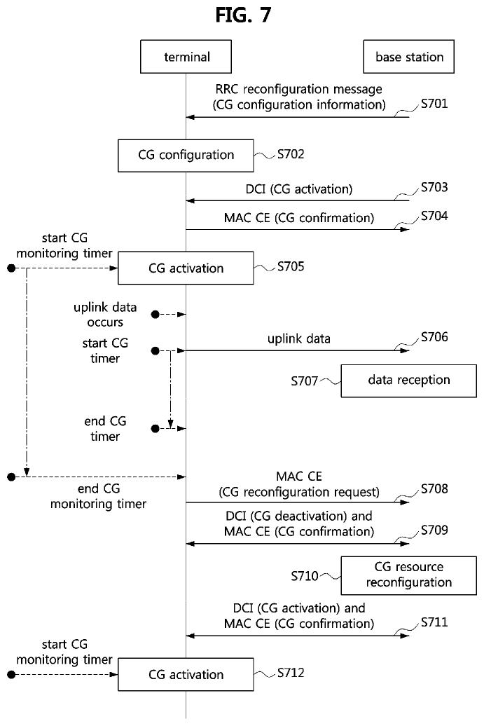

FIG. 6 is a sequence chart illustrating a first exemplary embodiment of a CG resource reconfiguration method when the CG type 1 scheme is used in a communication system, and FIG. 7 is a sequence chart illustrating a first exemplary embodiment of a CG resource reconfiguration method when the CG type 2 scheme is used in a communication system.

Referring to FIGS. 6 and 7, a communication system may include a base station and a terminal. The base station may be the base station 110-1, 110-2, 110-3, 120-1, or 120-2 shown in FIG. 1, and the terminal may be the terminal 130-1, 130-2, 130-3, 130-4, 130-5, or 130-6 shown in FIG. 1. Each of the base station and the terminal may be configured identically or similarly to the communication node 200 shown in FIG. 2.

When the CG type 1 scheme is used, steps S601 to S604 shown in FIG. 6 may be performed identically or similarly to the steps S301 to S304 shown in FIG. 3 except that the RRC reconfiguration message includes parameters (e.g., information elements) for CG resource reconfiguration. The step S604 may include a DMRS detection step, a CRC operation step, and a data decoding step, which are detailed steps.

When the CG type 2 scheme is used, steps S701 to S707 shown in FIG. 7 may be performed identically or similarly to the steps S401 to S407 shown in FIG. 4 except that the RRC reconfiguration message and/or activation DCI includes parameters (e.g., information elements) for CG resource reconfiguration. The step S707 may include a DMRS detection step, a CRC operation step, and a data decoding step which are detailed steps.

1. Procedure of Configuring Parameters for CG Resource Reconfiguration

The RRC reconfiguration message transmitted in the steps S601 and S701 may be used to configure a DRB and a logical channel for a CG. The RRC reconfiguration message may include RLC-BearerConfig IE, logicalChannelConfig IE, ConfiguredGrantConfig IE, and the like. RLC-BearerConfig may include logicalChannelIdentity, drb-Identity, LogicalChannelConfig, and the like. The logicalChannelConfig IE may include parameters (e.g., information elements) defined in Table 1.

The ConfiguredGrantConfig IE of the RRC reconfiguration message for the CG type 1 scheme may include the common parameters for the CG type 1 scheme and the CG type 2 scheme and the parameters for the CG type 1 scheme defined in Table 2. The ConfiguredGrantConfig IE of the RRC reconfiguration message for the CG type 2 scheme may include the common parameters for the CG type 1 scheme and the CG type 2 scheme defined in Table 2. In addition, the ConfiguredGrantConfig IE of the RRC reconfiguration message may further include parameters for CG resource reconfiguration defined in Table 5 below.

TABLE 5

| | IE |
|---|---|
| Parameters for CG resource | maxNrofConfiguredGrantRlcSeg |
| reconfiguration | configuredGrantMaxRlcSduSize |
| | maxNrofConfiguredGrantHarqRetx |
| | aveNrofConfiguredGrantHarqRetx |
| | configuredGrantMonitoringRlcTimer |
| | configuredGrantMonitoringMacTimer |

When the RRC reconfiguration message of the step S601 or step S701 is received, the terminal may map a DRB index to an LCID by using RLC-BearerConfig included in the RRC reconfiguration message. The terminal may configure CG parameters for a DRB and a logical channel based on a CG index (e.g., configuredGrantConfigIndexMAC included in ConfiguredGrantConfig) included in allowedCG-List in configuration information of the logical channel (e.g., logicalChannelConfig).

When the CG type 1 scheme is used, the terminal may configure parameters for the CG (e.g., frequency hopping, DMRS, index of the MCS table, frequency allocation scheme, power control, repeated transmission, HARQ process ID, CG resource periodicity, frequency resource, time resource, TBS, and/or the like) based on ConfiguredGrantConfig included in the RRC reconfiguration message, and activate the configured parameters.

When the CG type 2 scheme is used, the terminal may configure basic parameters for the CG (e.g., frequency hopping, DMRS, index of the MCS table, frequency allocation scheme, power control, repeated transmission, HARQ process ID, and/or the like) based on ConfiguredGrantConfig included in the RRC reconfiguration message. In addition, the terminal may configure main parameters for the CG (e.g., periodicity of CG resource, frequency resource, time resource, TBS, and/or the like) based on the activation DCI received from the base station, and may activate the CG (e.g., basic parameters and main parameters for the CG).

When the CG type 1 scheme or the CG type 2 scheme is used, the terminal may identify the parameters for CG resource reconfiguration included in the RRC reconfiguration message, and may configure the parameters for CG resource reconfiguration. maxNorofConfiguredGrantRlcSeg defined in Table 5 may indicate the maximum number of RLC segmentations (e.g., segmentations of an RLC SDU). configuredGrantMaxMcSduSize defined in Table 5 may indicate the maximum size of the RLC SDU. maxNrofConfiguredGrantHarqRetx defined in Table 5 may indicate the maximum number of HARQ retransmission operations. aveNrofConfiguredGrantHarqRetx defined in Table 5 may indicate the average number of HARQ retransmission operations. configuredGrantMonitoringRlcTimer or configuredGrantMonitoringMacTimer defined in Table 5 may indicate a value of a monitoring timer for CG resource reconfiguration. configuredGrantMonitoringRlcTimer may be a value of a monitoring timer used in the RLC layer of the terminal, and configuredGrantMonitoringMacTimer may be a value of a monitoring timer used in the MAC layer of the terminal.

The operation of configuring and/or activating the CG parameters (e.g., CG configuration information) included in the above-described RRC reconfiguration message may be performed in the step S602 shown in FIG. 6 or the step S702 shown in FIG. 7. When the CG type 2 scheme is used, DCI (i.e., DCI) for CG activation may be transmitted/received. For example, in the step S703 shown in FIG. 7, the base station may transmit activation DCI to the terminal. The activation DCI may be distinguished from DCI for CG deactivation (hereinafter, referred to as ‘deactivation DCI’). The DCI transmitted from the base station to the terminal in the step S709 shown in FIG. 7 may be the deactivation DCI.

When all the conditions defined in Table 6 below are satisfied, the terminal may determine received DCI as the activation DCI. In this case, the terminal may transmit a MAC CE for CG confirmation to the base station (S704), and may activate the CG based on the activation DCI (S705). In the steps S703 and S711 shown in FIG. 7, the DCI (i.e., activation DCI) transmitted from the base station to the terminal may be configured as shown in Table 6 below.

TABLE 6

A CRC of the DCI is scrambled by a CS-RNTI
An NDI included in the DCI is set to 0
When only one CG is configured
All bits of a HARQ process number field included in the DCI are
set to 0
All bits of a redundancy version (RV) field included in the DCI
are set to 0
When one or more CGs are configured
All bits of the RV field included in the DCI are set to 0
A value of the HARQ process number field included in the
DCI indicates an index of CG configuration to be activated
(i.e., CG configuration index is a value of
configuredGrantConfigIndex included in ConfiguredGrantConfig).

When all the conditions defined in Table 7 below are satisfied, the terminal may determine received DCI as the deactivation DCI. In this case, in the step S709 shown in FIG. 7, the terminal may transmit a MAC CE for CG confirmation to the base station. In the step S709 shown in FIG. 7, the DCI (i.e., deactivation DCI) transmitted from the base station to the terminal may be configured as shown in Table 7 below.

TABLE 7

A CRC of the DCI is scrambled by a CS-RNTI
An NDI included in the DCI is set to 0
When only one CG is configured
All bits of a HARQ process number field included in the DCI are
set to 0
All bits of a redundancy version (RV) field included in the DCI
are set to 0
All bits of an MCS field included in the DCI are set to 1
In case of a Frequency Domain Resource Assignment field included
in the DCI
When a subcarrier spacing is 15 kHz, and a resource allocation
type is set to 2, all bits in the Frequency Domain Resource
Assignment field are set to 1.
When the subcarrier spacing is 30 kHz, and the resource allocation
type is set to 2, all bits in the Frequency Domain Resource
Assignment field are set to 0.
When one or more CGs are configured
All bits of the RV field included in the DCI are set to 0
All bits of the MCS field included in the DCI are set to 1
In case of a Frequency Domain Resource Assignment field included
in the DCI
When the subcarrier spacing is 15 kHz, and the resource allocation
type is set to 2, all bits in the Frequency Domain Resource
Assignment field are set to 1.
When the subcarrier spacing is 30 kHz, and the resource allocation
type is set to 2, all bits in the Frequency Domain Resource
Assignment field are set to 0.
A value of the HARQ process number field included in the DCI
indicates an index of CG configuration to be deactivated (i.e.,
CG configuration index is a value of configuredGrantConfigIndex
included in ConfiguredGrantConfig).

2. Procedure of Monitoring for CG Resource Reconfiguration

When the CG type 1 scheme is used, in the step S602 shown in FIG. 6, the terminal may start a CG monitoring timer after the CG activation. When the CG type 2 scheme is used, in the step S705 shown in FIG. 7, the terminal may start a CG monitoring timer after the CG activation. When the CG monitoring timer is started, the RLC layer and/or the MAC layer of the terminal may perform a monitoring operation in a preconfigured period to determine whether reconfiguration of the CG resource is required. The monitoring operation may be performed to determine whether uplink communication according to the CG satisfies latency requirements. The preconfigured period may be a period from a start time of the CG monitoring timer to an end time of the CG monitoring timer.

1) Monitoring Scheme #1 (Monitoring Operation Performed at the RLC Layer)

The terminal (e.g., the RLC layer of the terminal) may identify the number of segmentations and/or the maximum size of the RLC SDU for the DRB in which the CG is configured in a preconfigured period (e.g., period according to configuredGrantMonitoringRlcTimer). The number of segmentations and/or the maximum size of the RLC SDU may be used to determine the latency of uplink communication. The terminal may trigger a CG resource reconfiguration request when one or more of the following conditions are satisfied. That is, when one or more of the following conditions are satisfied, the terminal may determine that the uplink communication according to the CG does not satisfy the latency requirements. If the following condition(s) is not satisfied, the terminal may start the CG monitoring timer again and may perform a monitoring operation in a preconfigured period.
Condition #1: The number of segmentations of the RLC SDU is greater than or equal to a threshold (e.g., maxNrofConfiguredGrantRlcSeg defined in Table 5)
Condition #2: The maximum size of the RLC SDU is greater than or equal to a threshold (e.g., configuredGrantMaxRlcSduSize defined in Table 5)

2) Monitoring Scheme #2 (Monitoring Operation Performed at the MAC Layer)

The terminal (e.g., the MAC layer of the terminal) may identify the number of times the HARQ retransmission operation is performed for the logical channel in which the CG is configured in a preconfigured period (e.g., period according to configuredGrantMonitoringNacTimer). The number of times the HARQ retransmission operation is performed (e.g., the maximum number of times or the average number of times) may be used to determine the latency of uplink communication. The terminal may trigger a CG resource reconfiguration request when one or more of the following conditions are satisfied. That is, when one or more of the following conditions are satisfied, the terminal may determine that the uplink communication according to the CG does not satisfy the latency requirements. If the following condition(s) is not satisfied, the terminal may start the CG monitoring timer again and may perform a monitoring operation in a preconfigured period.
Condition #1: The number of HARQ retransmission operations is greater than or equal to a threshold (e.g., maxNrofConfiguredGrantHarqRetx defined in Table 5)
Condition #2: The average number of times the HARQ retransmission operation is performed is greater than or equal to a threshold (e.g., aveNrofConfiguredGrantHarqRetx defined in Table 5)

3. Procedure of Requesting CG Resource Reconfiguration

If it is determined that the uplink communication according to the CG does not satisfy the latency requirements, a request for reconfiguration of the CG resource may be triggered. When the CG resource reconfiguration request is triggered, the terminal (e.g., the MAC layer of the terminal) may generate a MAC CE for the CG reconfiguration request, and may transmit the MAC CE to the base station. The MAC CE for the CG reconfiguration request may be transmitted to the base station through a CG resource (e.g., PUSCH resource). In exemplary embodiments, the MAC CE for the CG reconfiguration request may be referred to as a ‘configured grant reconfiguration request (CGRR)-MAC CE’. When the CG type 1 scheme is used, the CGRR-MAC CE may be the MAC CE transmitted from the terminal to the base station in the step S605 shown in FIG. 6.

When the CG type 2 scheme is used, the CGRR-MAC CE may be the MAC CE transmitted from the terminal to the base station in the step S708 shown in FIG. 7. When the CGRR-MAC CE is received from the terminal, the base station may transmit DCI (i.e., deactivation DCI) indicating deactivation of the CG associated with the CGRR-MAC CE to the terminal, and the terminal receiving the deactivation DCI may transmit a MAC CE to the base station as confirmation on the deactivation DCI (S709). The CGRR-MAC CE may be configured as follows.

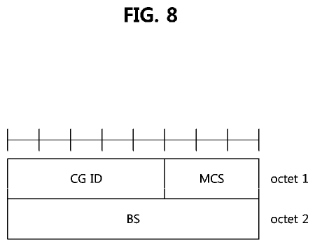

FIG. 8 is a conceptual diagram illustrating a first exemplary embodiment of a CGRR-MAC CE in a communication system.

Referring to FIG. 8, the CGRR-MAC CE may include a CG ID field, an MCS field, and a buffer size (BS) field. The CG ID field may be set to a CG ID (e.g., CG index). The CG ID field may be used to indicate a specific CG when one or more CGs are configured. The MCS field may be used to request a change of an MCS level of the CG (e.g., CG indicated by the CG ID field). The MCS field may be set based on the number of HARQ retransmission operations measured in the procedure of monitoring for CG resource reconfiguration. For example, the MCS field set to ‘010’ may request to maintain the MCS level, the MCS field set to ‘001’ may request to lower the MCS level, and the MCS field set to ‘100’ may request to increase the MCS level.

In addition, the MCS field may indicate an increase/decrease range of the MCS level as needed. For example, when the increase range set by the MCS field is 2, the MCS field may request to change the current MCS level to the MCS level increased by 2. When the decrease range set by the MCS field is 3, the MCS field may request to change the current MCS level to the MCS level decreased by 3.

The BS field may be used to request a change of the CG (e.g., a resource of the CG indicated by the CG ID field). The BS field may be set based on the maximum size of the RLC SDU measured in the procedure of monitoring for CG resource reconfiguration. A value (e.g., index) of the BS field may indicate a specific buffer size as shown in Table 8 below.

TABLE 8

| Value of BS | |
|---|---|
| field | Buffer size |
| 0 | 0 |
| 1 | 0 < BS ≤ 10 |
| 2 | 10 < BS ≤ 14 |
| 3 | 14 < BS ≤ 20 |
| 4 | 20 < BS ≤ 28 |
| 5 | 28 < BS ≤ 38 |
| 6 | 38 < BS ≤ 53 |
| 7 | 53 < BS ≤ 74 |
| 8 | 74 < BS ≤ 102 |
| 9 | 102 < BS ≤ 142 |
| 10 | 142 < BS ≤ 276 |
| 11 | 276 < BS ≤ 535 |
| 12 | 535 < BS ≤ 745 |
| 13 | 745 < BS ≤ 1038 |
| 14 | 1038 < BS ≤ 1446 |
| 15 | 2014 < BS ≤ 2014 |

Referring again to FIGS. 6 and 7, when there is no data to be transmitted in the CG resource, the terminal (e.g., the MAC layer of the terminal) may transmit a configured grant reconfiguration (CGR)-MAC CE to the base station in the CG resource. The MAC layer of the terminal may generate the CGR-MAC CE including a subheader composed of a reserved bit(s) and an LCID. Padding may be added to the CGR-MAC CE. The MAC layer of the terminal may deliver a MAC PDU including the CGR-MAC CE to the PHY layer of the terminal.

On the other hand, the base station may perform a DMRS detection operation in the CG resource, and when a DMRS is detected in the CG resource, the base station may determine that data and/or a MAC CE are transmitted from the terminal. In this case, the base station may perform a CRC operation, and may perform a decoding operation when the CRC operation is successful. When the CGRR-MAC CE is received from the terminal, the base station (e.g., the MAC layer of the base station) may reconfigure the CG resource (e.g., periodicity of the CG resource, frequency resource, time resource, and/or TBS) based on the MCS level and/or buffer size indicated by the CGRR-MAC CE, and transmit information on the reconfigured CG resource to the terminal.

When the CG type 1 scheme is used (e.g., the exemplary embodiment shown in FIG. 6), the base station may reconfigure the CG resource based on the information included in the CGRR-MAC CE received from the terminal (S606), and may transmit an RRC reconfiguration message including information on the reconfigured CG resource (e.g., CG reconfiguration information) to the terminal (S607). The terminal may receive the RRC reconfiguration message from the base station, may configure a CG (e.g., periodicity of CG resource, frequency resource, time resource, TBS, etc.) based on the information included in the RRC reconfiguration message, and may activate the configured CG (S608). In this case, the terminal may perform uplink communication using the reconfigured CG resource.

When the CG type 2 scheme is used (e.g., the exemplary embodiment shown in FIG. 7), the base station may receive the CGRR-MAC CE from the terminal. In this case, the base station may transmit DCI requesting deactivation of the CG associated with the CGRR-MAC CE (i.e., deactivation DCI) to the terminal (S709). The terminal may receive the deactivation DCI from the base station, and may deactivate the CG associated with the deactivation DCI. The terminal may transmit a MAC CE to the base station as confirmation on the deactivation DCI (S709). The step S709 may be an optional operation.

The base station may reconfigure the CG resource based on the information included in the CGRR-MAC CE received from the terminal (S710), and may transmit DCI (i.e., activation DCI) including information on the reconfigured CG resource (e.g., CG reconfiguration information) to the terminal (S711). The terminal may receive the activation DCI from the base station, and may transmit a MAC CE to the base station as confirmation on the activation DCI (S711). The terminal may activate the CG (e.g., periodicity of the CG resource, frequency resource, time resource, TBS, etc.) based on the information included in the activation DCI (S712). In this case, the terminal may perform uplink communication using the reconfigured CG resource.

The exemplary embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the exemplary embodiments of the present disclosure and their advantages have been described in detail, it should be understood that various changes, substitutions and alterations may be made herein without departing from the scope of the present disclosure.

What is claimed is:

1. An operation method of a terminal in a communication system, the operation method comprising:
receiving, from a base station, a radio resource control (RRC) message including configured grant (CG) configuration information and parameters for a reconfiguration request on a CG resource configured by the CG configuration information;
performing a monitoring operation for uplink communication according to the CG configuration information in a period indicated by a first parameter among the parameters;
transmitting, to the base station, a medium access control (MAC) control element (CE) requesting reconfiguration of the CG resource, when a result of the monitoring operation satisfies a second parameter among the parameters; and
receiving, from the base station, configuration information of the CG resource reconfigured according to the MAC CE.

2. The operation method according to claim 1, wherein the first parameter is a monitoring timer, and the period is a period from a start time of the monitoring timer to an end time of the monitoring timer.

3. The operation method according to claim 2, wherein in case that a CG type 1 scheme is used, the monitoring timer starts when a CG is activated by the CG configuration information, and in case that a CG type 2 scheme is used, the monitoring timer starts when downlink control information (DCI) requesting activation of a CG is received the base station.

4. The operation method according to claim 1, wherein the result of the monitoring operation indicates a number of segmentations of a radio link control (RLC) service data unit (SDU) transmitted in the CG resource, and when the number of segmentations is equal to or greater than a threshold according to the second parameter, the MAC CE is transmitted to the base station.

5. The operation method according to claim 1, wherein the result of the monitoring operation indicates a maximum size of an RLC SDU transmitted in the CG resource, and when the maximum size is equal to or greater than a threshold according to the second parameter, the MAC CE is transmitted to the base station.

6. The operation method according to claim 1, wherein the result of the monitoring operation indicates a number of times of performing a hybrid automatic repeat request (HARQ) retransmission operation for data transmitted in the CG resource, and when the number of times is greater than or equal to a threshold according to the second parameter, the MAC CE is transmitted to the base station.

7. The operation method according to claim 1, wherein the MAC CE includes first information indicating a CG associated with the CG resource for which reconfiguration is requested, second information requesting a change of a modulation and coding scheme (MCS) level for the CG indicated by the first information, and third information requesting a change in a buffer size for the CG indicated by the first information.

8. The operation method according to claim 1, further comprising, before the receiving of the configuration information of the reconfigured CG resource, receiving, from the base station, DCI requesting deactivation of the CG resource for which the reconfiguration is requested by the MAC CE.

9. The operation method according to claim 1, wherein when a CG type 1 scheme is used, the configuration information of the reconfigured CG resource is included in an RRC configuration message, and when a CG type 2 scheme is used, the configuration information of the reconfigured CG resource is included in DCI.

10. An operation method of a base station in a communication system, the operation method comprising:
transmitting, to a terminal, a radio resource control (RRC) reconfiguration message including configured grant (CG) configuration information and parameters for a reconfiguration request on a CG resource configured by the CG configuration information;
receiving, from the terminal, a medium access control (MAC) control element (CE) requesting reconfiguration of the CG resource in the CG resource;
reconfiguring the CG resource based on information included in the MAC CE; and
transmitting, to the terminal, configuration information of the reconfigured CG resource.

11. The operation method according to claim 10, wherein the parameters include a first parameter indicating a monitoring timer for the reconfiguration request on the CG resource, a second parameter indicating a threshold for a number of segmentations of a radio link control (RLC) service data unit (SDU) transmitted in the CG resource, a third parameter indicating a threshold for a maximum size of the RLC SDU, and a fourth parameter indicating a threshold for a number of times of performing a hybrid automatic repeat request (HARQ) retransmission operation for data transmitted in the CG resource.

12. The operation method according to claim 10, wherein the MAC CE includes first information indicating a CG associated with the CG resource for which reconfiguration is requested, second information requesting a change of a modulation and coding scheme (MCS) level for the CG indicated by the first information, and third information requesting a change in a buffer size for the CG indicated by the first information.

13. The operation method according to claim 10, further comprising, when the MAC CE is received, transmitting, to the terminal, downlink control information (DCI) requesting deactivation of the CG resource.

14. The operation method according to claim 10, wherein when a CG type 1 scheme is used, the configuration information of the reconfigured CG resource is included in an RRC configuration message, and when a CG type 2 scheme is used, the configuration information of the reconfigured CG resources is included in DCI.

15. A terminal in a communication system, the terminal comprising:
a processor;
a memory electronically communicating with the processor; and
instructions stored in the memory,
wherein when executed by the processor, the instructions cause the terminal to:
receive, from a base station, a first message including configured grant (CG) configuration information and parameters for a reconfiguration request on a CG resource configured by the CG configuration information;
perform a monitoring operation for uplink communication according to the CG configuration information in a period indicated by a first parameter among the parameters; and
in response to determining that a transmission latency for the uplink communication occurs by the monitoring operation, transmit, to the base station, a second message requesting reconfiguration of the CG resource.

16. The terminal according to claim 15, wherein when a number of segmentations of a radio link control (RLC) service data unit (SDU) transmitted in the CG resource, a maximum size of the RLC SDU, or a number of performing a hybrid automatic repeat request (HARQ) retransmission operation for data transmitted in the CG resource is equal to or greater than a second parameter among the parameters, it is determined that the transmission latency occurs.

17. The terminal according to claim 15, wherein the second message includes first information indicating a CG associated with the CG resource for which reconfiguration is requested, second information requesting a change of a modulation and coding scheme (MCS) level for the CG indicated by the first information, and third information requesting a change in a buffer size for the CG indicated by the first information.

18. The terminal according to claim 15, wherein the instructions cause the terminal to receive, from the base station, downlink control information (DCI) requesting deactivation of the CG resource for which reconfiguration is requested by the second message.

19. The terminal according to claim 15, wherein the instructions cause the terminal to receive, from the base station, a third message including configuration information of the CG resource reconfigured according to the second message.

20. The terminal according to claim 19, wherein when a CG type 1 scheme is used, the third message is a radio resource control (RRC) reconfiguration message, and when a CG type 2 scheme is used, the third message is DCI.
